(19) United States
(12) Patent Application Publication
(10) Pub. No.: US 2011/0050694 A1
(43) Pub. Date: Mar. 3, 2011

(54) SYSTEM AND METHOD FOR RENDERING HAIR IMAGE

(76) Inventors: Hye Sun Kim, Daejeon (KR); Yun Ji Ban, Daejeon (KR); Seung Woo Nam, Daejeon (KR); Chung Hwan Lee, Daejeon (KR)

(21) Appl. No.: 12/635,593

(22) Filed: Dec. 10, 2009

(30) Foreign Application Priority Data
Sep. 1, 2009 (KR) 10-2009-0082054

(51) Int. Cl. G09G 5/02; G06T 15/60

(52) U.S. Cl. 345/426; 345/592; 345/593

(57) ABSTRACT

Provided are a system and method for rendering hair image which smoothly and vividly render a fiber type of long and slim object like hair when creating 3D content. The system includes a sampling point setting module, a transparency determination module and a color value determination module. The sampling point setting module sets a plurality of sampling points in a hair geometry region. The transparency determination module determines transparency of a pixel the hair geometry region, on the basis of the sampling point. The color value determination module determines a color value of the pixel on the basis of shading values for each of the sampling points.

### CROSS-REFERENCE TO RELATED APPLICATIONS

This application claims priority under 35 U.S.C. §119 to Korean Patent Application No. 10-2009-82054, filed on Sep. 1, 2009, in the Korean Intellectual Property Office, the disclosure of which is incorporated herein by reference in its entirety.

### TECHNICAL FIELD

The following disclosure relates to a system and method for rendering hair image, in particular, to a system and method for rendering hair image, which smoothly and vividly render a fiber type of long and slim object like hair when creating Three-Dimensional (3D) contents.

### BACKGROUND

Hair rendering technology, which enables to render a cylinder type of long, slim and semitransparent geometries on a large scale without flicker, is essential for the creation of 3D image content.

As a related art of rendering method, there is a method that triangulates hair data, generated in a 3D curve type, into a cylinder or plane type of ribbon to perform rendering. In that method, a thick hair may be smoothly rendered. But there is a limitation to render a fine hair. For example, rendering might be excessively performed, whereupon hair is exaggerated and seen larger than real hair. When a degree of rendering is low, hair is omitted in sampling and is not seen at all. These limitations cause flicker when hair is rendered as consecutive images, for example, a moving picture.

The quality may be improved by increasing the number of sampling times in a triangle-based rendering method, but it takes a long time.

### SUMMARY

In one general aspect, a system for rendering hair image includes: a sampling point setting module setting a plurality of sampling points in a hair geometry region; a transparency determination module determining transparency of a pixel through which the hair geometry region passes, on the basis of the sampling points; and a color value determination module determining a color value of the pixel on the basis of shading values for each of the sampling points.

In another general aspect, a method for rendering hair image includes: setting a sampling reference point for one pixel in a hair geometry region; setting a plurality of sampling points with respect to the sampling reference point; determining transparency of the pixel on the basis of thicknesses of the hair geometry region for each of the sampling points; and determining a color value of the pixel on the basis of shading values for each of the sampling points.

Other features and aspects will be apparent from the following detailed description, the drawings, and the claims.

### BRIEF DESCRIPTION OF THE DRAWINGS

FIG. 1 is a block diagram schematically illustrating the concept of environment to which a system for rendering hair image according to an exemplary embodiment is applied.

FIG. 2 is a block diagram schematically illustrating a system for rendering hair image according to an exemplary embodiment.

FIG. 3 is an exemplary diagram illustrating an example of setting sampling reference points, in a system for rendering hair image according to an exemplary embodiment.

FIG. 4 is an exemplary diagram illustrating an example of setting sampling points, in a system for rendering hair image according to an exemplary embodiment.

FIG. 5 is an exemplary diagram conceptually illustrating a method for calculating the area of a hair geometry region for each pixel.

FIGS. 6 and 7 are exemplary diagrams illustrating an example of a method for calculating an area A in FIG. 5.

FIG. 8 is a diagram numerically illustrating the calculation results of areas which are calculated in the method of FIG. 5.

FIG. 9 is a flow chart illustrating a method for rendering hair image according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In specification, hair includes all objects having a shape such as a slim and long fiber.

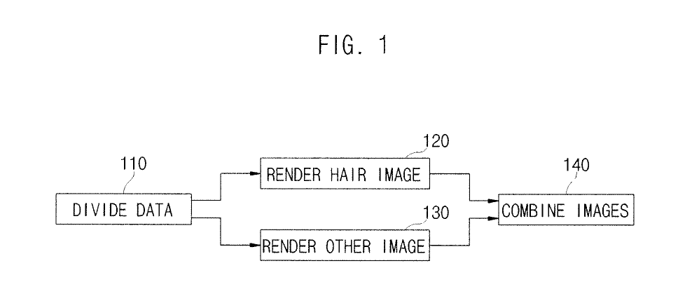

FIG. 1 is a block diagram schematically illustrating the concept of environment to which a system for rendering hair image according to an exemplary embodiment is applied. In creating 3D image contents, image data obtained through a camera are divided into hair image data and other image data (for example, a face) in operation 110. Because the hair image data and the other image data respectively have unique data type identifiers, they may be divided according to the data type identifier.

The hair image data are rendered by the system for rendering hair image according to an exemplary embodiment in operation 120. The other image data are rendered by a triangle-based rendering method in operation 130. The triangle-based rendering method and hair image rendering method according to an exemplary embodiment which is a line-based rendering method cannot be applied at the same time. So, the hair image and the other image are rendered separately and combined to generate an image for 3D image content.

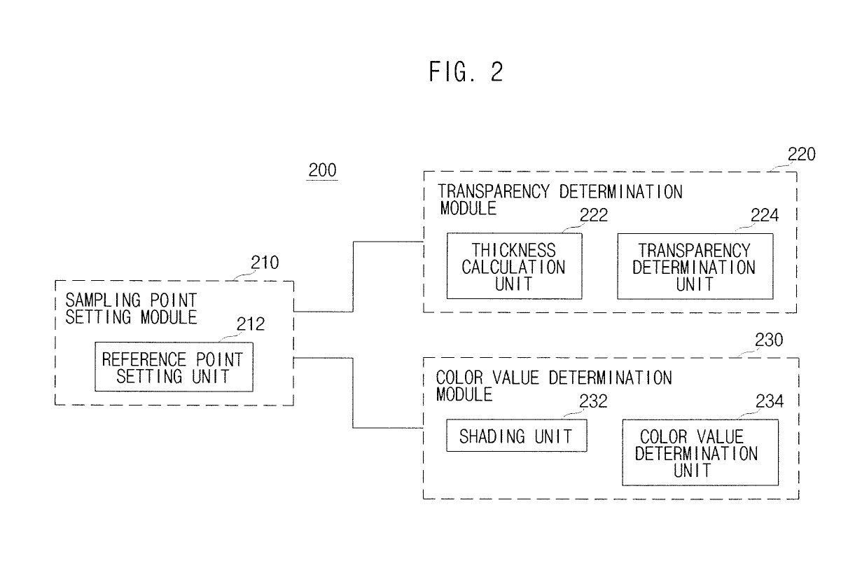

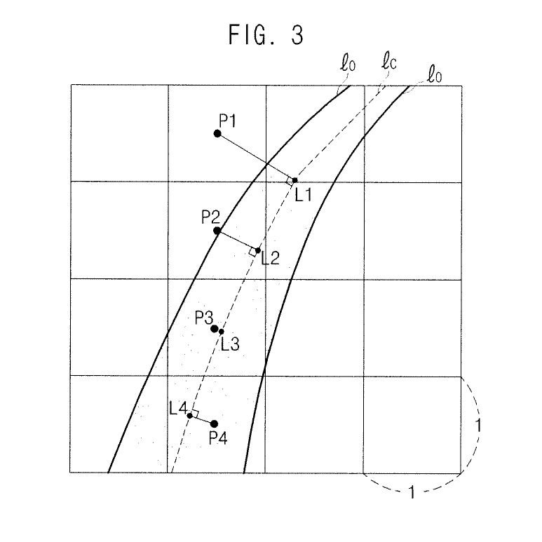

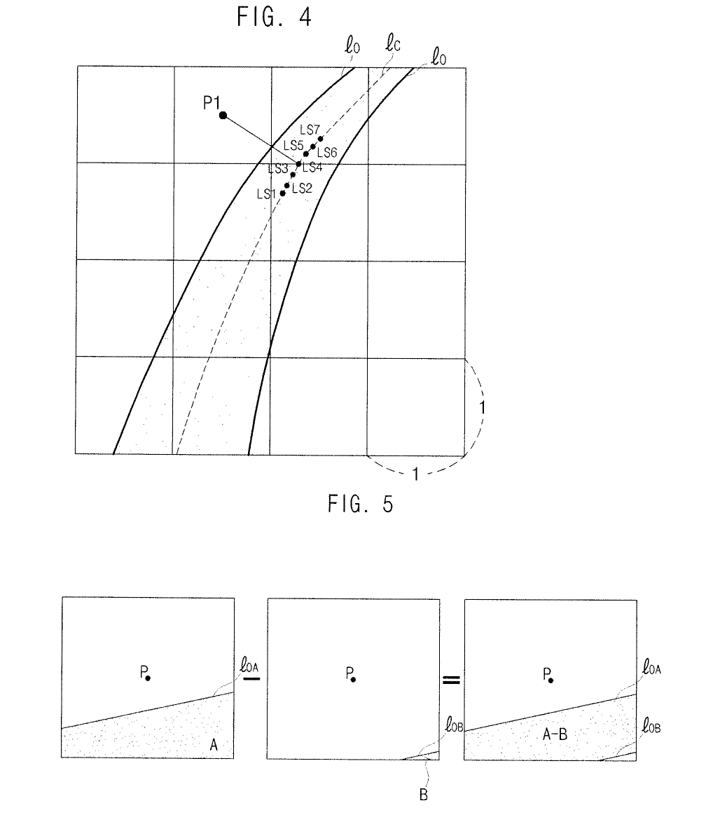

Hereinafter, a system for rendering hair image according to an exemplary embodiment will be described with reference to FIG. 2. Referring to FIG. 2, a system 100 for rendering hair image according to an exemplary embodiment includes a sampling point setting module 210, a transparency determination module 220, and a color value determination module 230. FIG. 2 is a block diagram schematically illustrating a system for rendering hair image according to an exemplary embodiment. FIG. 3 is an exemplary diagram illustrating an example of setting sampling reference points, in a system for rendering hair image according to an exemplary embodiment. FIG. 4 is an exemplary diagram illustrating an example of setting sampling points, in a system for rendering hair image according to an exemplary embodiment. FIG. 5 is an exemplary diagram illustrating an example of determining the transparency of each pixel, in a system for rendering hair image according to an exemplary embodiment. In FIGS. 3 to 5, one lattice denotes one pixel, l_{O} denotes the outer line of a hair geometry region, and l_{C} denotes the center line of the hair geometry region.

The sampling point setting module 210 sets a plurality of sampling points in the hair geometry region. A plurality of sampling points are set for one pixel.

As an example, when the reference point setting unit 212 of the sampling point setting module 210 draws a perpendicular line from the center of a pixel to the center line of the hair geometry region, the sampling point setting module 210 sets the point of intersection between the perpendicular line and the center line as a reference point. Setting a sampling reference point through the reference point setting unit 212 is performed for a plurality of pixels, respectively.

The sampling point setting module 210 sets a plurality of sampling points with respect to the sampling reference point. Setting the plurality of sampling points is performed for a plurality of sampling reference points, respectively. The sampling points may be disposed on the center line of the hair geometry region like the sampling reference point, and set to be symmetrical about the sampling reference point. The sampling reference point may be any one of the sampling points.

The sampling point becomes basis in determining the transparency and color value of each pixel. Accordingly, the number and/or intervals of sampling points may be controlled according to the quality of hair image rendering as a final result. For obtaining the high-quality result of hair image rendering, for example, many sampling points may be set or the intervals between the sampling points may be narrowly set. If the curvature of the hair geometry region is large, the intervals between the sampling points should be narrowly set.

FIG. 3 illustrates an example of setting sampling reference points, in a system for rendering hair image according to an exemplary embodiment. As shown in FIG. 3, when the reference point setting unit 212 draws perpendicular lines from the centers P1 to P4 of pixels to the center line l_{C} of the hair geometry region respectively, the points of intersection between the perpendicular lines and the center line l_{C} is set as sampling reference points L1 to L4 respectively. In this way, the reference point setting unit 212 sets a sampling reference point for each pixel. For convenience, FIG. 3 shows the sampling reference points of only four pixels.

FIG. 4 illustrates sampling points which are set with respect to the sampling reference point of a pixel having the center P1 among the pixels in FIG. 3. Six sampling points LS1, LS2, LS3, LS4, LS5, LS6, and LS7 are set with respect to the sampling reference point L1. The sampling points LS1 to LS3 are symmetrical with the sampling points LS5 to LS7 about the sampling reference point L1. As described above, the sampling reference point L1 may become any one LS4 of the sampling points (i.e., L1=LS4).

The transparency determination module 220 determines the transparency of each pixel on the basis of the thickness of the hair geometry region for each sampling point. The transparency determination module 220 includes a thickness calculation unit 222, and a transparency determination unit 224.

The thickness calculation unit 222 calculates the thickness of the hair geometry region for each sampling point. In FIG. 4, since the number of sampling points is seven (the sampling points LS1 to LS7), the number of thicknesses that are calculated for each sampling point becomes seven.

The transparency determination unit 224 calculates the area of a hair geometry region for each pixel on the basis of the thickness of the hair geometry region for each sampling point, and determines the transparency of the each pixel according to the area. As parameters for calculating the area of the hair geometry region for each pixel, there are the distance from the center of a pixel to the center line of the hair geometry region, the thickness of the hair geometry region and the slope of the hair geometry region. A method for calculating an area will be described below with reference to FIGS. 5 to 7.

The transparency of the each pixel is inversely proportional to the area of the hair geometry region for each pixel. For example, when the area of a hair geometry region passing over a pixel is 0, a corresponding pixel is transparent. When the area of a hair geometry region passing over a pixel is 1, the opacity of a corresponding pixel is the maximum. When the area of a hair geometry region passing over a pixel exceeds 0, as the area of the hair geometry region passing over the pixel increases, the opacity of a corresponding pixel increases.

FIG. 5 illustrates a method for calculating the area of a hair geometry region for each pixel. For convenience, it is assumed that the size of each pixel is “1×1”. First, the system 200 calculates the area A of any one side region of a pixel that is divided by an outer line l_{OA} near the center of the pixel. The system 200 calculates the area B of any one side region of a pixel that is divided by another outer line l_{OB} farther away from the center of the pixel. Subsequently, the absolute value of difference between the area A and the area B becomes the area of a hair geometry region for each pixel.

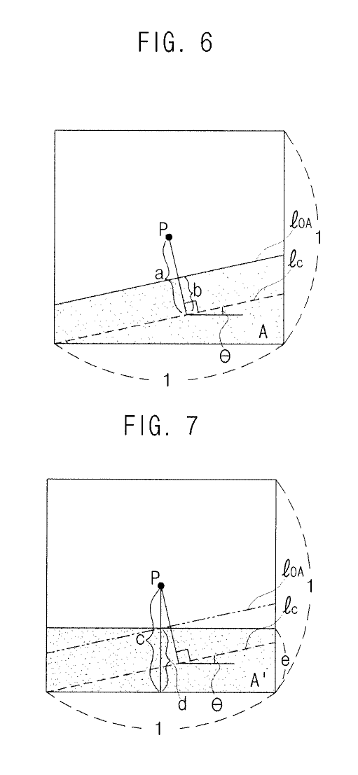

FIGS. 6 and 7 are exemplary diagrams illustrating an example of a method for calculating the area A in FIG. 5. Parameters for calculating the area A are the distance from the center of a pixel to the center line of the hair geometry region, the thickness of the hair geometry region and the slope of the hair geometry region. In FIG. 6, ‘a’ is the distance from the center of a pixel to the center line of the hair geometry region, and as the slope of the hair geometry region, θ is the slope of the center line. ‘b’ represents half of the average value of thicknesses for each sampling point that is calculated by the thickness calculation unit 222.

The area A in FIG. 6 is the same as an area A′ in FIG. 7. In FIG. 7, ‘c’ is “a/cos θ”, and ‘d’ is “b/cos θ”. Accordingly, ‘e’ becomes “0.5−(c-d)”. As a result, the area A is expressed as Equation (1) below.

$$A = 1 \# e = 0.5 \frac{\begin{matrix}a & b\end{matrix}}{cos !} \qquad ( 1 )$$

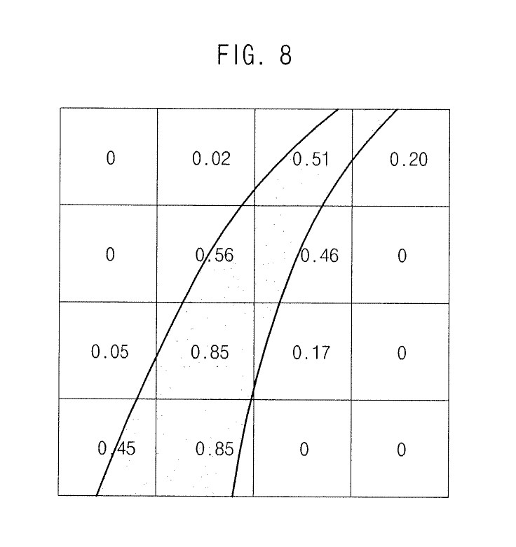

Because the area B may be calculated by using the parameters as described above, the area of a hair geometry region for one pixel is calculated. The transparency determination unit 224 calculates the area of the hair geometry region per pixel. FIG. 8 is a diagram numerically illustrating the calculation results of areas calculated in the method which has been described above with reference to FIG. 5.

The transparency determination unit 224 determines the transparency of each pixel on the basis of the area of a hair geometry region for each pixel. In FIG. 8, for example, the transparency of a pixel having an area of 0.56 is 44 when being numerically expressed, and the transparency of a pixel having an area of 0.02 is 98 when being numerically expressed.

The color value determination module 230 determines the color value of each pixel on the basis of a shading value for each sampling point. The color value determination module 230 includes a shading unit 232 that performs shading for each sampling point to calculate shading values, and a color value determination unit 234 that determines the color value of a corresponding pixel on the basis of the shading values.

As shading parameters, there are the location, a degree of hiding and curvature of the hair geometry region. The values of the shading parameters differ from one another per sampling point. Accordingly, the shading unit 232 calculates a shading value for each sampling point, and the color value determination unit 234 determines the color value of a pixel on the basis of the shading values.

The shading unit 232 calculates shading values on the basis of shading parameters, for example, normal, vertex color, and opacity. There are various kinds of shaders that perform shading. In the shading unit 232, the shader may be selected by a user. In FIG. 4, the shading value is calculated for each of the sampling points LS1 to LS7.

The color value determination unit 234 may determine the average value or maximum value of the shading values as the color value of a corresponding pixel. Or, the color value determination unit 234 may determine a filter value, in which weight is given to the shading values, as the color value. In FIG. 4, for example, the color value determination unit 234 may give weight to a sampling point near the sampling point LS4 of the seven sampling points by using Gaussian, sinc, and triangle. The average value of shading values for each of the sampling points LS1 to LS7 may become the color value of a pixel having the center P1.

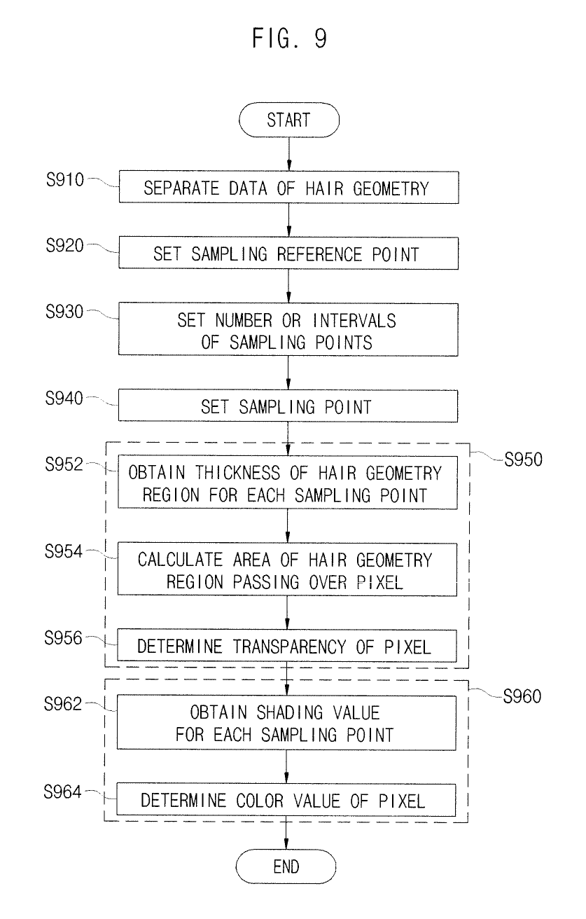

Hereinafter, a method for rendering hair image according to an exemplary embodiment will be described with reference to FIG. 9. FIG. 9 is a flow chart illustrating a method for rendering hair image according to an exemplary embodiment.

The system 200 separates the data of hair geometry from image data in operation S910. As shown in FIG. 3, a hair geometry region based on data is disposed on pixels.

The sampling point setting module 210 sets a sampling reference point in a hair geometry region in operation S920, and sets a plurality of sampling points with respect to the sampling reference point in operation S940. By drawing a perpendicular line from the center of each pixel to the center line of the hair geometry region for setting the sampling reference point, the point of intersection between the perpendicular line and the center line is generated. The point of intersection becomes the sampling reference point. The number of sampling reference points corresponding to one pixel is one.

The sampling point reference module 210 may set a plurality of sampling points to be symmetrical about the sampling reference point. The sampling point may be disposed on the same line as the sampling reference point.

The number of sampling points or the intervals between the sampling points is received from a user that uses the method for rendering hair image in operation 5930, and the sampling points may be set on the basis of the number of sampling points or the intervals between the sampling points. As the number of sampling points increases or the intervals between the sampling points become narrower, quality for rendering gets high.

In an exemplary embodiment, the sampling reference point may become a virtual reference point for setting the sampling points. In another exemplary embodiment, alternatively, the sampling reference point is a sampling point and may be used to determine the transparency and color value of each pixel.

Since a hair image has a feature in which the thickness is continuously changing, the thickness of a hair geometry region becomes an important parameter in determining the transparency of each pixel. Accordingly, when the sampling point is set in operation S940, the thickness calculation unit 222 obtains the thickness of the hair geometry region for each sampling point in operation S952. Because the number of sampling points is plural, the number of thicknesses of the hair geometry region becomes plural. For example, as shown in FIG. 4, when the number of sampling points is seven (for example, the sampling points LS1 to LS7), seven thicknesses are obtained.

The transparency determination unit 224 calculates the area of a hair geometry region that passes over one pixel on the basis of the average value of the thickness values of the hair geometry region for each sampling point in operation S954, and determines the transparency of a corresponding pixel according to the hair geometry region in operation S956.

As parameters for calculating the area of the hair geometry region, the distance from the center of a pixel to the center line of the hair geometry region and the slope of the hair geometry region may be further included, in addition to the average value of the thicknesses of the hair geometry region. A method, which calculates the area of a hair geometry region for each pixel by using the parameters, is the same as the method that has been described above with reference to FIGS. 5 to 7.

When the sampling points are set in operation S640, the color value determination module 230 performs shading for each sampling point to obtain a shading value corresponding to a result of the shading in operation S662, and determines a color value per pixel on the basis of the shading value in operation S664. Since the number of sampling points is plural, the number of shading values becomes plural. The color value per pixel may be the average value of the plurality of shading values or the maximum value of the shading values.

The above-described operations S910 to S960 are repetitively performed per pixel, so that the system 200 may determine all the transparencies and color values of a plurality of pixels.

As the method for rendering hair image according to an exemplary embodiment, operation S660 of determining the color value after operation S650 of determining transparency has been described above in FIG. 6, but they are not limited thereto. That is, operation 5660 of determining the color value may be performed before operation 5650 of determining transparency.

According to another exemplary embodiment, when there are few sampling points or the intervals between the sampling points are broad, the thickness of a hair geometry region may be obtained through an interpolation scheme on the basis of thickness that is calculated in each of the sampling points, at point where the sampling point is not set.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for rendering hair image, the system comprising:
a sampling point setting module setting a plurality of sampling points in a hair geometry region;
a transparency determination module determining transparency of a pixel for the hair geometry region, on the basis of the sampling points; and
a color value determination module determining a color value of the pixel on the basis of shading values for each of the sampling points.

2. The system of claim 1, wherein the sampling point setting module comprises a reference point setting unit setting a sampling reference point on a center line of the hair geometry region, and sets the plurality of sampling points with respect to the sampling reference point.

3. The system of claim 2, wherein when drawing a perpendicular line from a center of the pixel to the center line, the reference point setting unit sets a point of intersection between the perpendicular line and the center line as the sampling reference point.

4. The system of claim 1, wherein the number or intervals of the sampling points is controlled according to quality for the hair image rendering or a curvature of the hair geometry region.

5. The system of claim 1, wherein the transparency determination module comprises:
a thickness calculation unit calculating thicknesses of the hair geometry region for each of the sampling points; and
a transparency determination unit calculating an area of the hair geometry region per pixel on the basis of the thickness to determine transparency per pixel.

6. The system of claim 5, wherein the transparency determination unit calculates the area using a distance from a center of the pixel to a center line of the hair geometry region, an average value of the calculated thicknesses and a slope of the hair geometry region as parameters.

7. The system of claim 5, wherein the transparency determination unit determines an absolute value of difference between an area for one side region of the pixel that is divided by an outer line near the center of the pixel among outer lines of the hair geometry region and an area for one side region of the pixel that is divided by an outer line farther away from the center of the pixel among the outer lines of the hair geometry region.

8. The system of claim 1, wherein the color value determination module determines a maximum value of the shading values, an average value of the shading values or a filter value to which a weight for each of the sampling points is given, as the color value of the pixel.

9. A method for rendering hair image, the method comprising:
setting a sampling reference point for one pixel in a hair geometry region;
setting a plurality of sampling points with respect to the sampling reference point;
determining transparency of the pixel on the basis of thicknesses of the hair geometry region for each of the sampling points; and
determining a color value of the pixel on the basis of shading values for each of the sampling points.

10. The method of claim 9, wherein the setting of a sampling reference point comprises:
drawing a perpendicular line from a center of the pixel to a center line of the hair geometry region; and
setting a point of intersection between the perpendicular line and the center line as the sampling reference point.

11. The method of claim 9, wherein the sampling reference point is any one of the sampling points.

12. The method of claim 9, wherein, in the setting of a plurality of sampling points, the sampling points are set to be symmetrical about the sampling reference point.

13. The method of claim 9, further comprising receiving the number or intervals of the sampling points.

14. The method of claim 9, wherein the determining of transparency comprises:
obtaining the thicknesses of the hair geometry region for each of the sampling points;
calculating an area of the hair geometry region per pixel on the basis of an average value of the thicknesses; and
determining transparency of the pixel on the basis of the area.

15. The method of claim 9, wherein the determining of a color value comprises determining a maximum value of the shading values, an average value of the shading values or a filter value to which a weight for each of the sampling points is given, as the color value of the pixel.

16. The method of claim 9, wherein the setting of a sampling reference point, the setting of a plurality of sampling points, the determining of transparency and the determining of a color value are repetitively performed by the number of pixels for the hair geometry region.
